(19) United States
(12) Patent Application Publication
(10) Pub. No.: US 2026/0266943 A1
(43) Pub. Date: Sep. 10, 2026

(54) Method for processing a one-dimensional signal, corresponding device and program

(71) Applicant: CENTRALESUPELEC, Gif-sur-Yvette (FR)

(72) Inventor: Piotr Antonik, Gif-sur-Yvette (FR)

(21) Appl. No.: 19/113,640

(22) PCT Filed: Sep. 20, 2023
(86) PCT No.: PCT/EP2023/075976

§ 371 Date: May 18, 2026

(30) Foreign Application Priority Data
Sep. 21, 2022 (FR) 2209536

(51) Int. Cl. G01S 1/10; H04L 67/50; H04W 64/00

(52) U.S. Cl. CPC G01S 1/10; H04W 64/006; H04L 67/535

(57) ABSTRACT

The invention relates to a method and device for characterising an event occurring within a space comprising an apparatus for receiving WLAN signals, the method being implemented by an electronic processing device. A method of this type comprises:
a standardisation step (P_1) of the input data aimed at reducing the resolution of a plurality of sequences of WLAN signals received by the said receiving equipment, delivering a plurality of compressed sequences; and
a processing step (P_2) of the plurality of compressed sequences by an echo state network comprising a predetermined number N of nodes, delivering a probability of belonging of each compressed sequence to a class among a set of predetermined event classes.

### 1. TECHNICAL FIELD

The disclosure relates to the field of presence and/or movement detection within an environment. More particularly, the disclosure relates to the field of detecting the presence of moving objects and/or persons using existing equipment and/or equipment that is inexpensive to install. In a particular operating context, the disclosure applies to a wireless domestic communication network, in particular of the Wi-Fi type, for example within a home.

### 2. PRIOR ART

For many years, keeping vulnerable people at home and monitoring events occurring within homes has been a major concern for both institutions and industry. The concern not only relates to the increased cost of accommodating vulnerable people in specialised institutions, but also to the desire of these same people to remain in their own homes. However, keeping people at home does not come without its problems, particularly those relating to safety issues: frail individuals who are alone at home are frequently the victims of domestic accidents. Solutions have been proposed to prevent such situations or to intervene as much as possible. For example, there are pendants that can be worn by elderly people, which allow them to press an emergency button in the event of an accident, which triggers one or more phone calls or transmission to a monitoring centre. Some pendants also have fall detection functions and can be triggered autonomously. In the same vein, new smartphones and smartwatches also have similar functions.

However, these devices, although effective, do pose a problem in that they need to be worn and need to have sufficient autonomy to function. Thus, other solutions that do not require a wearable device have been developed. A solution of this kind is described in patent application WO2020037313, in which a Wi-Fi network and signals exchanged between Wi-Fi equipment in the network are used. More specifically, it describes a system comprising multiple Wi-Fi-compatible devices, arranged in an environment and configured to be transmitters or receivers for transmitting or receiving data over a Wi-Fi radio frequency communication link. A remote server is configured to receive and analyse the channel status information data transmitted by the receiver, to store the channel status information (CSI) data with corresponding adequate labelling (human presence) collected for training, to train an identification classifier (of human presence) using a method of the Convex Clustered Concurrent Shapelet Learning (C3SL) method, and estimate the presence of a user based on the CSI data and the C3SL method. The server is configured to receive and analyse the CSI data transmitted by the receiver, in order to assign a corresponding gesture label and estimate and identify the gesture performed by the user using a trained target encoder and source classifier.

This solution has the aforementioned advantage of not requiring additional devices for detecting user gestures within a home. However, this solution does have several problems, including the need for a server device for processing channel state information (CSI) data, which processes this data remotely. Furthermore, the said technique uses a complex neural network, which requires significant resources to perform a fine classification of the movements made by the user.

### 3. SUMMARY OF THE INVENTION

The disclosure has been conceived in consideration of the disadvantages of the prior art.

The disclosure relates more particularly to a one-dimensional signal processing methodology, making it possible to detect the presence or movements of users. More particularly, the disclosure relates to a method of characterising an event occurring within a space comprising WLAN signal reception equipment, a method implemented by an electronic processing device. Such a method comprises:
a step of standardising the input data aimed at reducing the resolution of a plurality of sequences of WLAN signals received by said receiving equipment, delivering a plurality of compressed sequences; and
a step of processing the plurality of compressed sequences with an echo state network comprising a predetermined number N of nodes, delivering a probability of membership of each compressed sequence to one class out of a set of predetermined event classes.

It is thus possible to determine quickly, and with little available computing power, the presence or movements made by a user.

According to one particular feature, the step of standardising the input data aimed at reducing the resolution of the plurality of sequences of WLAN signals received, comprises:
a step of obtaining the plurality of signal sequences, each signal sequence comprising a variation of signal amplitude [one-dimensional]over time;
a step of compressing each signal sequence of the plurality of signal sequences, in which a sub-sampling of each signal sequence is carried out, such that the number of samples of each resulting compressed sequence is equal to a predetermined number K.

According to one particular feature, the compression step of each signal sequence of the plurality of signal sequences comprises, for a current signal sequence:
a step of re-encoding the current sequence with reduced precision, delivering a re-encoded sequence;
a step of filtering the re-encoded sequence by a low-pass linear filter, with a cut-off frequency with an upper limit of 24 Hz, delivering a filtered temporal sequence;
a step of resizing the filtered temporal sequence to obtain a zero-mean series with values in the interval [−1, +1];
a padding step of the resized sequence to produce a sequence of predetermined length;
a subsampling step to a predetermined number K of samples by averaging the values of said padded sequence over a number of intervals corresponding to the number K of samples.

According to one particular feature, the processing step of the plurality of sequences compressed by an echo state network comprises a step of optimising a predetermined number X of output weights of a predetermined number N of nodes of the echo state network such that each input signal sequence can be assigned to a predetermined event class from the set of predetermined event classes.

According to one particular feature, the optimisation step of the predetermined number X of output weights of the echo state network comprises a linear regression calculation step.

According to one particular feature, the linear regression calculation step comprises:
a step of concatenating a predetermined number of states of the echo state network which are selected from among the K states of the echo state network, delivering a concatenated state;
a step of calculating a linear regression to adjust the output weights of the echo state network according to the concatenated state.

According to one particular feature, the number N of nodes of the echo state network is between 25 and 250.

According to one particular feature, the number of samples K of each sequence is between 10 and 25.

According to another aspect, the invention also relates to an electronic device for characterising an event occurring within a space comprising WLAN signal reception equipment. Such a device comprises:
means of reducing the resolution of a plurality of sequences of WLAN signals received by said receiving equipment, delivering compressed sequences; and
means for processing compressed sequences via an echo state network comprising a predetermined number N of nodes, delivering a probability of belonging of each compressed sequence to one class of a set of predetermined event classes.

According to one preferred implementation, the various steps of the methods according to the present disclosure are implemented by one or more computer programs or software, comprising software instructions to be executed by a data processor of an electronic device implementing the present technique and being configured to control the execution of the various steps of the processes, implemented by an electronic processing device or communication equipment, for example a router or “box”, as part of a distribution of the processing to be carried out and determined by a scripted source code or a compiled code.

Consequently, the present technique also targets programs that can be executed by a computer or by a data processor, these programs including instructions for controlling the execution of steps of the methods such as those mentioned above.

A program may use any programming language, and be in the form of source code, object code, or byte code between source code and object code, such as in a partially compiled form, or in any other desirable form.

The present technique also targets an information medium that can be read by a data processor, and including instructions of a program such as mentioned above.

The information medium may be any entity or terminal capable of storing the program. For example, the medium may include a storage means, such as a ROM, for example a CD ROM or a microelectronic circuit ROM, or also a magnetic recording means, for example a mobile medium (memory card) or a hard drive or an SSD.

On the other hand, the information medium may be a transmissible medium such as an electrical or optical signal, which may be routed via an electrical or optical cable, by radio or by other means. The program according to the present technique may in particular be downloaded on an Internet type network.

Alternatively, the information medium may be an integrated circuit in which the program is incorporated, the circuit being suitable for executing or for being used in the execution of the method in question.

According to an embodiment, the present technique is implemented by means of software and/or hardware components. In this regard, the term “module” may correspond in this document to a software component as well as to a hardware component or to a set of software and hardware components.

A software component corresponds to one or more computer programs, one or more subprograms of a program, or more generally to any element of a program or of software capable of implementing a function or a set of functions, according to what is described below for the module concerned.

Such a software component is executed by a data processor of a physical entity (terminal, server, gateway, set-top-box, router, etc.) and is capable of accessing the hardware resources of this physical entity (memories, recording media, communication bus, input/output electronic cards, user interfaces, etc.).

In the same manner, a hardware component corresponds to any element of a hardware assembly capable of implementing a function or a set of functions, according to what is described below for the module concerned. This may concern a hardware component that can be programmed or with an integrated processor for executing software, for example an integrated circuit, a chip card, a memory card, an electronic card for executing firmware, etc.

Each component of the system described above of course implements its own software modules. The various embodiments mentioned above can be combined with one another to implement the present technique.

### 4. BRIEF DESCRIPTION OF THE FIGURES

Other aims, features and advantages of the invention will become clearer on reading the following description, which is given by way of a simple illustrative and non-limiting example, in relation to the figures, including:

FIG. 1 shows the characterisation method according to the present invention;

FIG. 2 explains the method used in more detail;

FIG. 3 is a diagram of an echo state network used in the context of the present invention;

FIG. 4 shows a simplified physical architecture of an electronic device that may be suitable for carrying out the method described.

### 5. DETAILED DESCRIPTION

### 5.1 Reminder of the Principle

As explained above, the disclosure differs from the prior art in the frugality of the resources used to classify the movements of users.

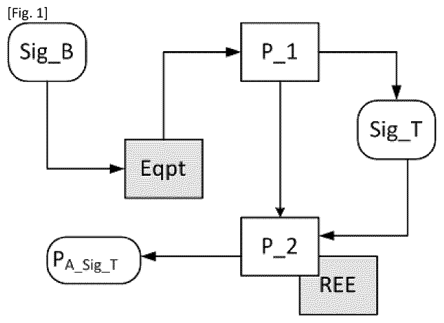

More particularly, in relation to FIG. 1, the disclosure relates to a method of characterising an event occurring within a space (such as a room, a set of communicating rooms, a hospital, an accommodation establishment or even a dwelling) including at least one piece of equipment for receiving WLAN (Wireless Local Area Network) signals, for example Wi-Fi. The method is implemented by an electronic processing device (which may be the Wi-Fi signal receiving equipment itself). The method comprises:
a step of standardising the input data aimed at reducing the resolution (P_1), of a plurality of sequences (Sig_B) of WLAN signals received by the said receiving equipment (Eqpt), delivering a plurality of compressed sequences (Sig_T); and
a processing step (P_2) of the plurality of compressed sequences (Sig_T) by an echo state network (ESN) comprising a predetermined number N of nodes, delivering a probability of membership (PA_sig_r) of each compressed sequence (Sig_T) to one class out of a set of predetermined event classes (for example, “lying down”, “falling”, “walking”, “running”, “sitting down”, “getting up”, but also “entering”, “exiting”, “opening a door”, “closing a door”, “opening a window”, “closing a window”, etc.).

The characterisation method has two modes of implementation: a learning mode and a use mode. The learning mode consists of determining operating parameters of the echo state network and the use mode consists of implementing the method with a configured echo state network.

More particularly, in learning mode, the method implements the signal data standardisation step and the processing step, which includes supervised learning of the standardised data using an echo state network, this processing making it possible to set the parameters of the echo state network. In use mode, the characterisation method also enables classification to be carried out, by implementing a signal data standardisation step, similar to the signal data standardisation step of the learning mode, and a step of classifying the standardised data, using the echo state network parameterised during an implementation of the method in learning mode.

More particularly, compared to the prior art, the characterisation method comprises a step of standardising the received signal data. This step provides a time sequence of standardised amplitude for a time sequence of input amplitude. The characterisation method also includes a classification step which, based on a standardised amplitude time sequence, provides a classification of the sequence. In the learning mode, this classification is adjusted, as explained below. This classification is presented in the form of at least one probability of the standardised time sequence belonging to a given class of movements. The network used is an ‘Echo State Network’ (ESN), comprising a small number of neurons. According to the present, the combination of the standardisation step, which leads to a significant simplification (similar to destructive compression) of the input signals, combined with the implementation of the echo state network, makes it possible to meet the requirements of reducing the use of resources at the same time as guaranteeing a result (i.e. confidence in the classification) superior to those obtained by the prior art technique, in particular due to the simplicity of the learning stage.

In the use mode, the characterisation process includes the step of standardising the received signal data (this data obviously being different from the data that was used for the parameterisation of the echo state network). The standardised data is then supplied to the echo state network, which performs the classification of the standardised data.

The classification step delivers a classification of the sequence or sequences from one or more input time sequences. This classification is in the form of at least one probability of the standardised time sequence belonging to a given class of events corresponding to movements.

In the implemented configuration, for the intended application, the sequence is categorised from an established list of movements (lying down, falling, walking, running, sitting down, standing up).

Certain classes can be associated with the triggering of security alerts (such as “falling” for example) for a surveillance program, also installed on one of the WLAN devices in the home or dwelling.

Thus, the proposed technique has many advantages:
it is non-invasive and non-intrusive;
it does not require wearing a particular object or sensor;
it is not very sensitive to obstacles and is not limited to a direct line of sight, as with a camera;
it is not very sensitive to variations in light and works day and night;
when used locally, for example on Wi-Fi equipment in the home (for example on a box), it does not reveal the identity of the actors and respects privacy (GDPR);
it has a low installation costs and a lower environmental impact because it uses existing WLAN devices and does not require additional hardware; and
it has low energy consumption during operation due to the absence of using a large network, the absence of transmission of large volumes of data over a communication network and the (destructive) compression performed on the input signal, which is then greatly simplified.

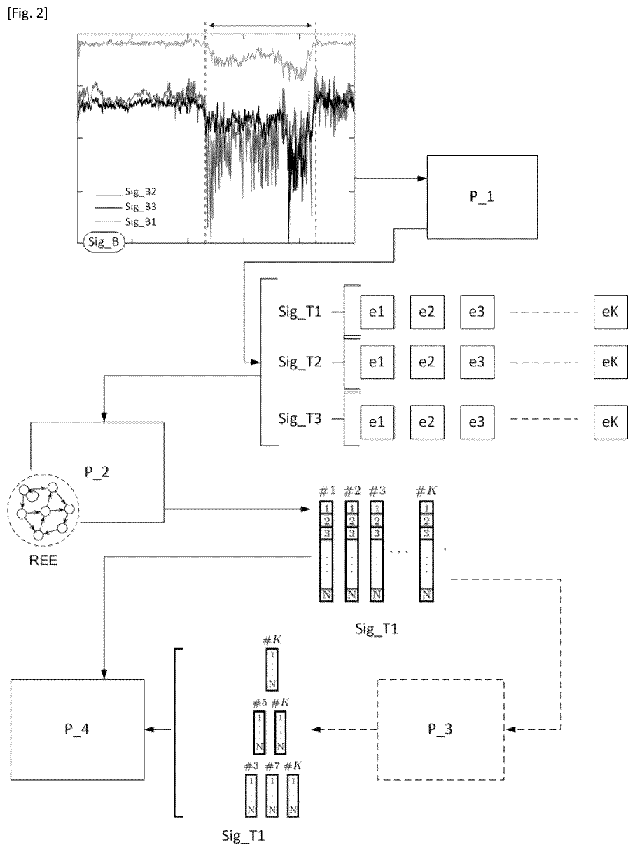

The various learning stages for configuring the echo state network (ESN) are presented in relation to FIG. 2. As part of the presentation of these stages, a particular example of a signal is illustrated. The raw signal (Sig_B) represented here comes from reception on 3 antennas (in light grey, dark grey and black) of WLAN equipment and corresponds to a disturbance induced by a person walking which is picked up on each of the antennas. The raw signal is therefore partitioned into 3 signals: the Sig_B 1 signal (in light grey) corresponds to the reception of the disturbance on the first antenna, the Sig_B2 signal (in dark grey) corresponds to the reception of the disturbance on the second antenna, the Sig_B3 signal corresponds to the reception of the disturbance on the third antenna. At the end of the standardisation step, (P_1), each resulting signal (Sig_T1, Sig_T2, Sig_T3) is standardised over K intervals, which results in the production of K samples (e1, e2, e3, . . . , eK) per signal (hence K×3 here) to be injected into the echo state network (ESN) with N nodes (N=7 in the figure, to simplify the illustration) during processing step (P_2). In a realistic configuration, for an example of this type, N is between 25 and 250 and the number of sequences to be processed is obviously much greater. At the end of this processing step, there are therefore K samples (per signal). For greater clarity, only Sig_T1 is represented.

Thus, at the end of the processing step (P2) of the first sample (e1), the result is a first state (#1).

Then, at the end of the second sample (e2), the result is a second state (#2), and so on until the injection of the last sample (eK) which delivers the last state (#K). As illustrated schematically, each sample produces a state of the reservoir (column vector of size N×1 containing the states of the N nodes of the network), and the K states are collected at the end of the processing (there are then K states for each portion of the original signal in light grey, dark grey and black).

In learning mode, the echo state network is then optimised (P_4) so that it can provide a probability of the signal portion belonging to a given class. According to the invention, this optimisation is carried out only on the output layer of the network, and not on its internal connections. This optimisation is carried out by performing a linear regression on all the output weights, so that the final (supervised) classification is obtained according to the different states of the reservoir. The echo state network has a temporal memory of the samples supplied to it, so that learning is carried out by memorizing the class of the different samples that are successively transmitted to it until a classification is obtained on the basis of the succession of samples that are injected.

With the aim of obtaining better classification results (for example for the training and learning of the echo state network), it is possible to proceed (optionally) with the concatenation (P_3) of different states of the reservoir in order to increase its capacity for memory and classification of events. The number and indices of the states [#1, . . . , #K] chosen for concatenation are determined according to the conditions (depending, for example, on the signal signature and the capacity of the echo state network to classify the samples on its own, as explained below). In the example in FIG. 2, the combinations of 1, 2 and 3 states are illustrated. In such a situation, the optimisation of the output weights is carried out on the concatenation of the states and not on a single state. This way of proceeding makes it possible, as explained below, to avoid the phenomenon of omission that can occur depending on the initial configurations chosen for the echo state network.

Thus, the inventors used WLAN signals to detect a change of situation in a particular environment.

The room in which the tests were conducted included a WLAN signal transmitter and suitable receivers. When these devices exchange packets, the electromagnetic waves are reflected and the rebounds of these electromagnetic waves are multiple in the room. The receiver therefore does not just receive a wave but a combination of signals reflected multiple times in the room. If an object in the room moves, the final combination of these rebounds changes, and this change can be detected. In the implemented configuration, the transmitting equipment had three antennas and transmitted at a frequency of 2.4 GHz, with each antenna having 30 channels. Thus, up to 90 time traces (raw signals) were collected for training the system. The number of channels specified here is specific to the recordings made in this configuration. In real conditions, this number may vary depending on the band chosen and the equipment available.

### 5.2 Description of an Embodiment

This example presents an embodiment that the inventors used for the implementation of the characterisation method, in learning mode, as previously described. The method involves the following steps:
a standardisation step (P_1) of the input data comprising:
a step of receiving, from a signal data reception module, time sequences comprising data representative of the channel state (CSI), comprising a variation in signal amplitude over time;
a data compression step, comprising, for each time sequence:
a sub-step of reducing the size of the time sequence: the sequence is re-encoded with simple precision (32 bits), delivering a re-encoded time sequence;
a sub-step of filtering the re-encoded time sequence with a low-pass linear filter, for example a 4th-order Butterworth filter, with a cut-off frequency of 24 Hz upper limit: this smoothing eliminates electromagnetic noise. In practice, the cut-off frequency is more frequently between 10 and 15 Hz.
a sub-step of resizing the filtered time sequence to obtain a zero-mean series with values in the interval [−1, +1]: this operation averages the signals and relativizes the amplitudes so as to obtain equalising data from each channel, for all sequences; the channels are considered equivalent for the processing carried out;
a padding sub-step: each sequence is either cut or lengthened to have a homogeneous size of data (for example 10 thousand or 20 thousand samples per sequence).
an averaging sub-step (sub-sampling): each sequence is sub-sampled to a predetermined number of samples (for example, from 10 to 100 samples depending on the averaging parameter) by averaging over a number of intervals corresponding to the number of samples. More particularly, for the intended application, the number of samples is between 5 and 100, more specifically between 10 and 25.
a processing step (P_2) comprising supervised learning (i.e. optimisation) (P_4) of the sequences within the echo state network, comprising a predetermined (and reduced) number of nodes. More particularly, for the intended application, the number of nodes is between 25 and 250 nodes, depending on the fineness of the movements to be recognised. In practice, a number of nodes equal to 50 is sufficient to classify the signals according to the six classes mentioned above (“lying down”, “falling”, “walking”, “running”, “sitting”, “standing up”). This is a compromise between the fineness of recognition of the event and the resulting computational load.

The inventors have determined that gesture recognition needs to exploit the natural dynamics of a dynamic system driven for calculation and that an echo state network is suitable for this problem.

Thus, the combination of judicious standardisation of input signals and an echo state network capturing and memorizing the dynamics of the signals offers a combination that solves the problems posed by previous techniques.

Echo state networks are very different from most physical systems. First of all, they operate in discrete time. Furthermore, they are generally fully connected, which is not possible for most physical systems. However, the use of such a network alone is not in itself a recipe for success, as it only works well if there is a good match between the dynamics of the system and what is expected for a given task. Thus, the function of the data standardisation step in the intended application is to simplify the capture of signal dynamics by eliminating non-representative disturbances thereof. The number of samples retained at the end of the standardisation varies according to the fineness of recognition of the movement carried out, as does the number of nodes of the echo state network.

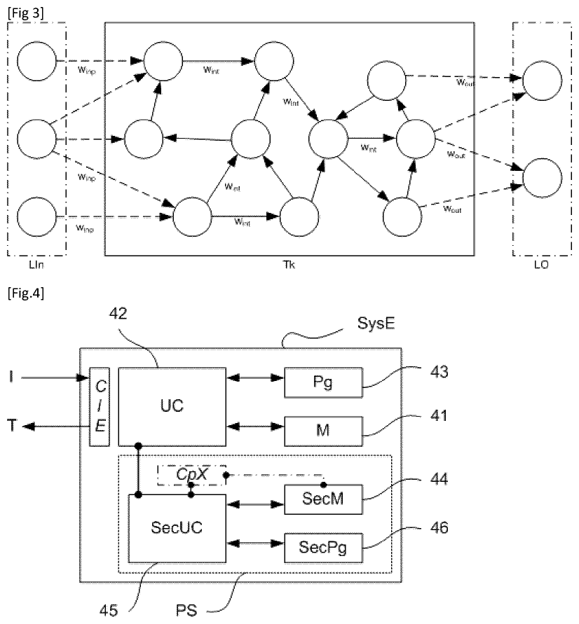

An echo state network used in the present context is illustrated schematically in FIG. 3. It is a network of nodes in which the input signal is connected to a fixed (i.e. non-trainable) and random dynamic system, referred to as the reservoir, thus creating a representation of larger dimension (incorporation).

To be more precise, the node network is shallow and consists of three layers:
an input layer (Lin);
a hidden internal layer (Tk), referred to as the reservoir;
and an output layer (LO).

On initialisation, the input nodes are connected to the reservoir and Wᵢₙₚ connection weights between the input layer and the reservoir are randomly generated.

The particular feature of this network relates to the feature that the reservoir nodes are sparsely connected and that the connections are assigned only once and are completely random. The weights Wᵢₙₜ of the reservoir are not trained and therefore not optimised.

To form the linear reading of the echo state network, the output weights Wₒᵤₜ are calculated by solving a system of linear equations Y=Wₒᵤₜ X, where the state matrix X and the target matrix Y are constructed using, respectively, x(n) and the target output vector y(n) in column form for each time instant (i.e. sample) tₙ (n is between 1 and K):
Random weights: Wᵢₙₚ, Wᵢₙₜ;
Optimizable weights (and optimised during training): Wₒᵤₜ;

### Evolution Equation:

$${x}_{i} ( n + 1 ) = f ( {\sum }_{j = 0}^{N - 1} {w}_{i n t}^{i j} {x}_{j} ( n ) + {w}_{i n p}^{i} u ( n ) )$$

Output layer delivering the states of the reservoir (column vector of size N×1 containing the states of the N nodes of the network):

$$y ( n ) = {\sum }_{i = 0}^{N - 1} {w}_{o u t}^{i} {x}_{i} ( n )$$

The connection weights Wₒᵤₜ between the reservoir and the output layer are optimised during learning (in step P_4), based on a linear relationship (for example by calculating a linear regression). There are as many output weights as there are neurons (the diagram in FIG. 3 is thus simplified for greater clarity).

Optimising the network amounts to solving a linear optimisation problem, using efficient and robust algorithms such as linear regression algorithms. The calculations are simple and fast, without recurring iterations, and make it possible to find an optimal value for the output weights given the desired classification.

The advantage of implementing an echo state network is that the sparse random connections in the reservoir allow previous states to “echo” even after they have passed, so that when the network receives a new input (a signal sample from the standardisation) similar to something it has trained on, the dynamics in the reservoir follow the activation trajectory appropriate for the input and in this way can provide a result corresponding to what it has been trained on, and when it is well trained, it can generalize from the signals it has already encountered, following activation trajectories that would make sense given the input signal driving the reservoir.

In the context of the invention and the standardisation carried out on the input signal (which basically has far too much information), the advantage is that the network does not require training on all the nodes to obtain good performance and is not very energy-intensive or computationally demanding.

More particularly, according to the present invention, the standardisation of the signal amplitudes delivers a predetermined K number of samples (for example between 10 and 25).

Each sample (of the predetermined number K of samples) is injected into the network of nodes.

Then, for each of these samples, the state of the system x, is captured at the output of the network (hidden internal layer). This gives K states of the system, or K SOI (States Of Interest) represented by the column matrices at the output of the reservoir.

The result y(n) is the class obtained by linear combination of a state x, with the weights wₒᵤₜ at the output layer level according to the previous equation. The output weights are optimised by linear regression to assign the correct class to the input signal.

Before optimisation, it is possible to carry out a concatenation step (P_3) of the outputs of the echo state network: in a clever way, the SOIs can be concatenated to improve the memory of the system.

For example, we could concatenate the x_{K} and x_{K-10} states to reinforce the presence of the first captures in the “memory” of the reservoir (these first captures would possibly be “attenuated” at the time of the Kth capture). Thus, by concatenating two output states, in the case where the node network comprises, for example, 50 nodes, a final state vector (column) (i.e. resulting from the concatenation) of 100×1 elements is obtained at the output layer (instead of 50×1 in the case of a single SOI) and 100 output weights are optimised instead of 50 during linear regression.

To determine the optimal number of SOIs to combine, as well as the particular SOIs to use, an iterative determination process can be optionally implemented during learning. In this process of determining the number of concatenations, the number of SOIs is set to 1 and K simulations are performed.

In each independent simulation, the reservoir is initialised from the beginning, and the entire database of pre-processed input signal recordings is passed through it.

In the first simulation, the first SOI x₁ is retained at the output layer (i.e. the state of the system after processing the first sample), the 50 readout weights are optimised (by linear regression) and the performance (classification accuracy) of the network is noted.

In the second simulation, the SOI x₂ is used, the output layer is trained and the performance is noted. And so on up to K simulations, where x_{K} is used for training. At the end of these K simulations, the best performance is selected and it is concluded that with a single SOI, the optimal choice is x, which gives an accuracy of X %.

Next, the number of SOIs is set at two (concatenation of two SOls), and K*((K−1)/2) simulations are carried out. In the first simulation, the states x₁ and x₂ are combined in a 100×1 vector (still for a network of 50 nodes), 100 read weights are optimised, and the performance is noted. In the second simulation, the states x₁ and x₃ are combined, and so on until the last simulation, where the states x_{K-1} and x_{K} are combined. The best performance of the K*((K−1)/2) simulations is selected and a conclusion is drawn regarding the best combination of 2 SOIs and the accuracy obtained.

This is done for three SOIs, then four SOIs, and so on. In practice, the inventors have determined that the level of performance reaches a plateau, beyond which adding more SOIs does not improve the final result. In the inventors' experience, concatenation of NbConcat=5 SOIs is sufficient to achieve optimal performance.

Concatenation increases the computational complexity of the training process, since the number of read weights increases linearly with concatenation: e.g. combining 2 reservoir states implies training 12N read weights instead of 6N (for the 6 binary output nodes and the N reservoir nodes). More specifically, the number of output nodes corresponds to the number of actions to be distinguished (in this case, 6: “lying down”, “falling”, “walking”, “running”, “sitting down”, “getting up”). In this example, rather than determining an output node for X actions to be distinguished (and therefore training the system to produce the responses from 1 to X corresponding to each class), X binary output nodes are defined, and each of the nodes is trained independently to produce 1 if the input corresponds to its class, and 0 otherwise. In practice, the output nodes produce real numbers between 0 and 1: each node gives a probability that the input corresponds to its class, and the binary output node that produces the highest value is selected to assign the class of the input.

### 5.3 Other Features and Advantages

In relation to FIG. 4, a simplified architecture of an electronic processing device (TC) capable of performing all or some of the processing operations as previously presented is presented. An electronic processing device comprises a first electronic module including a memory 41, a processing unit 42 equipped, for example, with a microprocessor and controlled by a computer program 43. The electronic processing device optionally includes, for security functions such as the anonymisation of signal data or states derived from these signals, a second electronic module comprising a secure memory 44, which can be merged with memory 41 (as indicated by the dotted line, in which case memory 41 is a secure memory), a secure processing unit 45 equipped, for example, with a secure microprocessor and physical protection measures (physical protection around the chip, by lattice, vias, etc. and protection on the data transmission interfaces), and controlled by a computer program 46 specifically dedicated to this secure processing unit 45, this computer program 46 implementing all or part of the characterisation process as previously described. The group composed of the secure processing unit 45, the secure memory 44 and the dedicated computer program 46 constitutes the secure module (SM) of the electronic processing device. In at least one embodiment, the present technique is implemented in the form of a set of programs installed in part or in whole on this secure portion of the electronic processing device. In at least one other embodiment, the present technique is implemented in the form of a dedicated component (CpX) capable of processing data from the processing units and installed in part or in whole on the secure portion of the electronic processing device. In addition, the device also includes communication means (CIE) that take the form, for example, of network components (WLAN, Wi-Fi, 3G/4G/5G, wired) that enable the device to receive data (I) from entities connected to one or more communication networks and to transmit processed data (T) to such entities.

Depending on embodiment, such a device comprises the means described above:
means of obtaining data representative of a signal; and in particular:
means of obtaining signal amplitude variation data as described above;
means of standardising the data representative of this signal;
means of processing the standardised data; and
means of optimising the output weights of an echo state network, these means being implemented during the learning of the class membership of the signals supplied to the system;
means of transmitting the class selected for the data representative of the input signal.

As explained above, these means are implemented by means of modules and/or components, which may be secure, for example. They thus ensure the security of the processing operations carried out.

1. A method comprising
characterising an event occurring within a space comprising wireless local area network (WLAN) signal reception equipment, the method being implemented by an electronic processing device and comprising:
standardizing the input data to reduce resolution of a plurality of sequences of WLAN signals received by the receiving equipment, delivering a plurality of compressed sequences; and
processing the plurality of compressed sequences by an echo state network comprising a predetermined number N of nodes, delivering a probability of belonging of each compressed sequence to a class among a set of predetermined event classes.

2. The method according to claim 1, wherein the standardizing comprises:
obtaining the plurality of signal sequences, each signal sequence comprising a variation in amplitude of a one-dimensional signal over time;
compressing each signal sequence of the plurality of signal sequences, in which a sub-sampling of each signal sequence is carried out, such that a number of samples of each resulting compressed sequence is equal to a predetermined number K.

3. The method according to claim 2, the compressing comprises, for a current signal sequence:
re-encoding the current sequence with reduced precision, delivering a re-encoded sequence;
filtering the re-encoded sequence by a low-pass linear filter, with a cut-off frequency with an upper limit of 24 Hz, delivering a filtered temporal sequence;
resizing the filtered temporal sequence to obtain a zero-mean series with values in the interval [−1, +1];
padding the resized sequence to produce a sequence of predetermined length;
subsampling to a predetermined number K of samples by averaging values of said padded sequence over a number of intervals corresponding to the number K of samples.

4. The method according to claim 1, wherein the processing of the plurality of sequences compressed by an echo state network includes optimizing a predetermined number X of output weights of a predetermined number N of nodes of the echo state network so that each input signal sequence can be assigned to a predetermined event class from the set of predetermined event classes.

5. The method according to claim 4, wherein the optimizing of the predetermined number X of output weights of the echo state network comprises calculating a linear regression.

6. The method according to claim 5, wherein the calculating a linear regression comprises:
concatenating a predetermined number of states of the echo state network which are selected from among the K states of the echo state network, delivering a concatenated state;
calculating a linear regression to adjust the output weights of the echo state network according to the concatenated state.

7. The method according to claim 1, wherein the number N of nodes of the echo state network is between 25 and 250.

8. The method according to claim 2, wherein the number of samples K of each sequence is between 10 and 25.

9. An electronic device for characterising an event occurring within a space comprising WLAN signal reception equipment, the device comprising:
at least one processor; and
a non-transitory computer readable medium comprising instructions stored thereon which when executed by the at least one processor configure the electronic device to:
reduce resolution of a plurality of sequences of WLAN signals received by said receiving equipment, delivering compressed sequences; and
process compressed sequences via an echo state network comprising a predetermined number N of nodes, delivering a probability of belonging of each compressed sequence to one class of a set of predetermined event classes.

10. A non-transitory computer readable medium comprising program code instructions stored thereon which when executed by a computer implement a method of characterising an event occurring within a space comprising wireless local area network (WLAN) signal reception equipment, the method comprising:
standardizing the input data to reduce resolution of a plurality of sequences of WLAN signals received by the receiving equipment, delivering a plurality of compressed sequences; and
processing the plurality of compressed sequences by an echo state network comprising a predetermined number N of nodes, delivering a probability of belonging of each compressed sequence to a class among a set of predetermined event classes.
